(19) United States
(12) Patent Application Publication
(10) Pub. No.: US 2025/0050304 A1
(43) Pub. Date: Feb. 13, 2025

(54) PACKING FOR USE IN A MASS TRANSFER COLUMN

(71) Applicant: Koch-Glitsch, LP, Wichita, KS (US)

(72) Inventors: Scott Clifford, Wichita, KS (US); Izak Nieuwoudt, Wichita, KS (US)

(21) Appl. No.: 18/782,077

(22) Filed: Jul. 24, 2024

Related U.S. Application Data
(60) Provisional application No. 63/531,561, filed on Aug. 9, 2023.

(51) Int. Cl. B01J 19/32

(52) U.S. Cl. CPC B01J 19/32; B01J 2219/32213; B01J 2219/32227; B01J 2219/32248; B01J 2219/32262

(57) ABSTRACT

A packing module for use in a mass transfer column has a plurality of packing elements positioned in an upright, parallel relationship to each other. Each packing element has a plurality of side-by-side and parallel longitudinal rows of arched outer rib elements that are connected at opposite ends to spaced apart side strips. The outer rib elements project outwardly in opposite directions from the side strips. In an upper edge region and a lower edge region at least one of the side strips in each longitudinal row converges toward the other side strip. The convergence of the side strips causes a reduction in length and outward projection of the outer rib elements that are connected at opposite ends to the converging side strips. The longitudinal rows of outer rib elements in adjacent packing elements are arranged in crisscrossing relationship to each other.

### BACKGROUND

The present disclosure relates to chemical processing columns in which mass transfer and/or heat exchange between fluid streams occurs and, more particularly, to random packing elements and structured packings used in such columns to facilitate contact between fluid streams flowing within the column.

Random packing elements and structured packings are normally employed in gas-liquid or liquid-liquid contact towers or columns to provide mass transfer surfaces between a downwardly flowing fluid, typically a liquid stream, and an upwardly ascending fluid, typically gas or vapor stream or another liquid stream. Random packing elements and structured packings may be used in a variety of chemical and treatment processes, such as, for example, rectification, stripping, fractionating, absorbing, separating, washing, extraction, or any other chemical, heat exchange, or treatment-type processes.

Random packing elements have a specific geometric shape and are designed to maximize performance for a given mass transfer surface area. The random packing elements are generally dumped or randomly packed into the column shell to form an arbitrarily orientated packed bed in which the gas and liquid passages are irregular and the contact time between the fluid phases is increased as a result of the longer fluid flow paths. It is desirable for the individual random packing elements to have both high mass transfer efficiency and good hydraulic capacity when positioned in multiple rotational orientations within the packed bed. An example of a random packing element having a plurality of arched rib elements that extend from a pair of side members is disclosed in U.S. Pat. No. 7,722,945 assigned to Koch-Glitsch, LP.

One type of structured packing uses a plurality of crimped sheets that form corrugations comprised of alternating peaks and valleys. The corrugated structured packing sheets are positioned in an upright, parallel relationship to each other and are arranged so that the corrugations of each sheet extend at an angle to a longitudinal axis of the column and at an angle with respect to the corrugations of each adjacent sheet in a crisscrossing relationship. The structured packing sheets are joined together to form a structured packing module in which uniform fluid passages are formed in the valleys of the crisscrossing corrugations. These fluid passages defined by the corrugations normally cause the structured packing to have a reduced pressure drop and higher processing capacity in comparison to random packing. An example of a structured packing module is disclosed in U.S. Pat. No. 10,953,382 assigned to Koch-Glitsch, LP.

### BRIEF DESCRIPTION

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying drawing figures.

In one aspect, the present disclosure is directed to a packing element for use in forming a packing module for use in a mass transfer column. The packing element comprises: opposite faces, an upper edge region, a lower edge region, a bulk region between the upper edge region and the lower edge region, an upper edge, and a lower edge; a plurality of side-by-side and parallel longitudinal rows of arched outer rib elements that are connected at opposite ends to spaced apart side strips and project outwardly in opposite directions from the side strips, wherein the longitudinal rows intersect the upper edge at an oblique angle and the lower edge at an oblique angle, in the bulk region the side strips in each longitudinal row extend in parallel relationship to each other, in the upper edge region at least one of the side strips in each longitudinal row converges toward the other side strip, in the lower edge region at least one of the side strips in each longitudinal row converges toward the other side strip, and convergence of the side strips causes a reduction in length and outward projection of the outer rib elements that are connected at opposite ends to the converging side strips.

In another aspect, the present disclosure is directed to a packing module for use in a mass transfer column. The packing module comprises: a plurality of the above-described packing elements positioned in an upright, parallel relationship to each other with the longitudinal rows of adjacent packing elements arranged in crisscrossing relationship to each other.

In a further aspect, the present disclosure is directed to a packing module for use in a mass transfer column. The packing module comprises: a plurality of the above-described packing elements positioned in an upright, parallel relationship to each other with the longitudinal rows of adjacent packing elements arranged in crisscrossing relationship to each other, and wherein: the upper edge is parallel to and separated by a distance from the lower edge, the upper edge and lower edge are formed by the converging side strips, the upper and lower edge regions each have a triangular projected area when viewed in projection on a plane parallel to a plane in which the side strips lie, the outer rib elements of the packing elements are in contact with the outer rib elements of adjacent packing elements, the arched outer rib elements cooperatively define the opposite faces of the packing element.

### BRIEF DESCRIPTION OF THE DRAWINGS

The present disclosure is described in detail below with reference to the attached drawing figures, wherein:

FIG. 1 is a perspective view of a mass transfer column with a portion of an external shell of the mass transfer column broken away to illustrate a packing module of the present disclosure positioned within an open internal region of the mass transfer column;

FIG. 2 is a top perspective view showing a number of packing sheets arranged in an upright, parallel relationship to each other to form a portion of the packing module shown in FIG. 1;

FIG. 3 is a top perspective view of two of the packing sheets shown in FIG. 2, with a portion of the front packing sheet broken away to show the crossing orientation of longitudinal rows of rib elements in the back packing sheet;

FIG. 4 is a fragmentary perspective view of the packing sheet showing a single longitudinal row of the rib elements;

FIG. 5 is a fragmentary side elevation view showing the single row of the rib elements shown in FIG. 4;

FIG. 6 is a front elevation view showing the single row of rib elements shown in FIGS. 4 and 5;

FIG. 7 is an enlarged fragmentary perspective view showing an upper edge region of the single row of rib elements shown in FIGS. 4-6;

FIG. 8 is an enlarged fragmentary perspective view similar to that shown in FIG. 7 but showing an opposite lower edge region of the single row of rib elements shown in FIGS. 4-6;

FIG. 9 is a fragmentary perspective view showing the upper edge region shown in FIG. 7 and taken from a different perspective from that shown in FIG. 7;

FIG. 10 is another fragmentary perspective view showing the upper edge region shown in FIG. 7 and taken from a different perspective from that shown in FIG. 7 and FIG. 9; and

FIG. 11 is a further fragmentary perspective view showing the upper edge region shown in FIG. 7 and taken from a different perspective from that shown in FIGS. 7, 9 and 10.

### DETAILED DESCRIPTION

The subject matter of the present disclosure is described with specificity herein to meet statutory requirements. However, the description itself is not intended to limit the scope of this patent. Rather, the inventors have contemplated that the claimed subject matter might also be embodied in other ways, to include different components, combinations of components, steps, or combinations of steps similar to the ones described in this document, in conjunction with other present or future technologies.

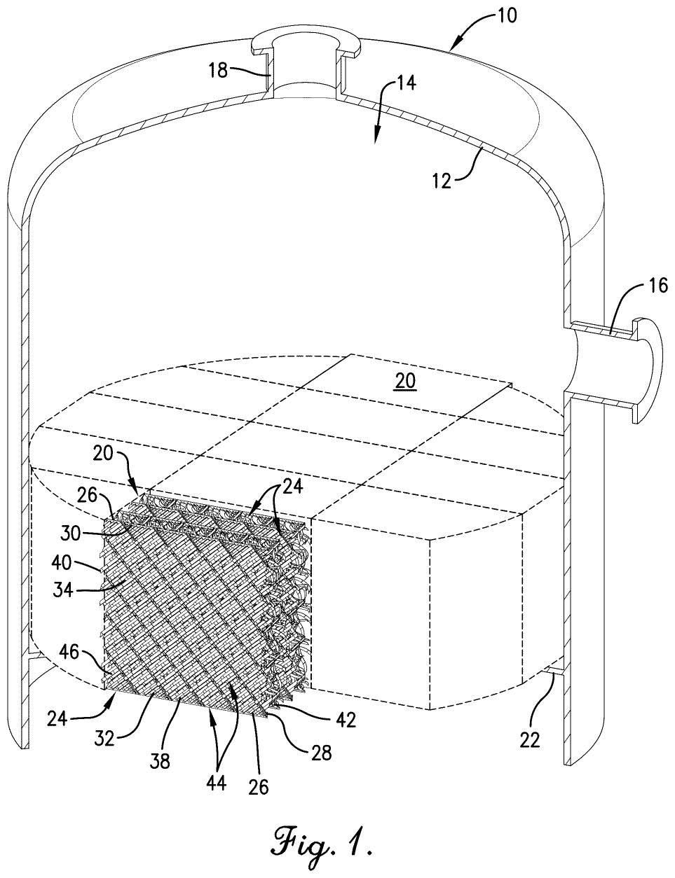

Turning now to the drawings in greater detail and initially to FIG. 1, a mass transfer column suitable for use in processes in which mass transfer and/or heat exchange is intended to occur between countercurrent-flowing fluid streams is represented generally by the numeral 10. As used herein, the term “mass transfer column” is intended to refer to columns in which mass transfer, heat exchange or mass transfer and heat exchange are intended to occur.

The mass transfer column 10 includes an upright, external shell 12 that is generally cylindrical in configuration, although other configurations, including polygonal, are possible and are within the scope of the present invention. The shell 12 is of any suitable diameter and height and is constructed from one or more rigid materials that are desirably inert to or are otherwise compatible with the fluids and conditions present during operation of the mass transfer column 10.

The mass transfer column 10 is of a type used for processing fluid streams, typically liquid and vapor streams, to obtain fractionation products and/or to otherwise cause mass transfer and/or heat exchange between the fluid streams. For example, the mass transfer column 10 may be one in which crude atmospheric, lube vacuum, crude vacuum, fluid or thermal cracking fractionating, coker or visbreaker fractionating, coke scrubbing, reactor off-gas scrubbing, gas quenching, edible oil deodorization, pollution control scrubbing, and other processes occur.

The shell 12 of the mass transfer column 10 defines an open internal region 14 in which the desired mass transfer and/or heat exchange between the fluid streams occurs. Normally, the fluid streams comprise one or more ascending vapor streams and one or more descending liquid streams. Alternatively, the fluid streams may comprise both ascending and descending liquid streams or an ascending gas stream and a descending liquid stream.

The fluid streams are directed to the mass transfer column 10 through any number of feed lines 16 positioned at appropriate locations along the height of the mass transfer column 10. One or more vapor streams may also be generated within the mass transfer column 10 rather than being introduced into the mass transfer column 10 through the feed lines 16. The mass transfer column 10 will also typically include an overhead line 18 for removing a vapor product or byproduct and a bottom stream takeoff line (not shown) for removing a liquid product or byproduct from the mass transfer column 10. Other mass transfer column components that may be present, such as reflux stream lines, reboilers, condensers, vapor horns, and the like, are not illustrated in the drawings because they are conventional in nature and an illustration of these components is not believed to be necessary for an understanding of the present disclosure.

A layer of packing modules 20 in one embodiment of the disclosure are shown positioned within the open internal region 14 of the mass transfer column 10. For simplicity of illustration, a single packing module 20 is illustrated and the remaining packing modules 20 are schematically represented. The packing modules 20 are positioned in side-by-side and end-to-end relationship and may completely fill a horizontal cross section of the mass transfer column 10. Multiple stacked layers of the packing modules 20 may be provided and adjacent stacked layers may be placed in rotated orientation to each other, such as at rotation angle of 90 degrees. The packing modules 20 may be supported by the shell 12 in a suitable fashion, such as using support beams (not shown) or support grids (not shown) that are supported by a support ring 22.

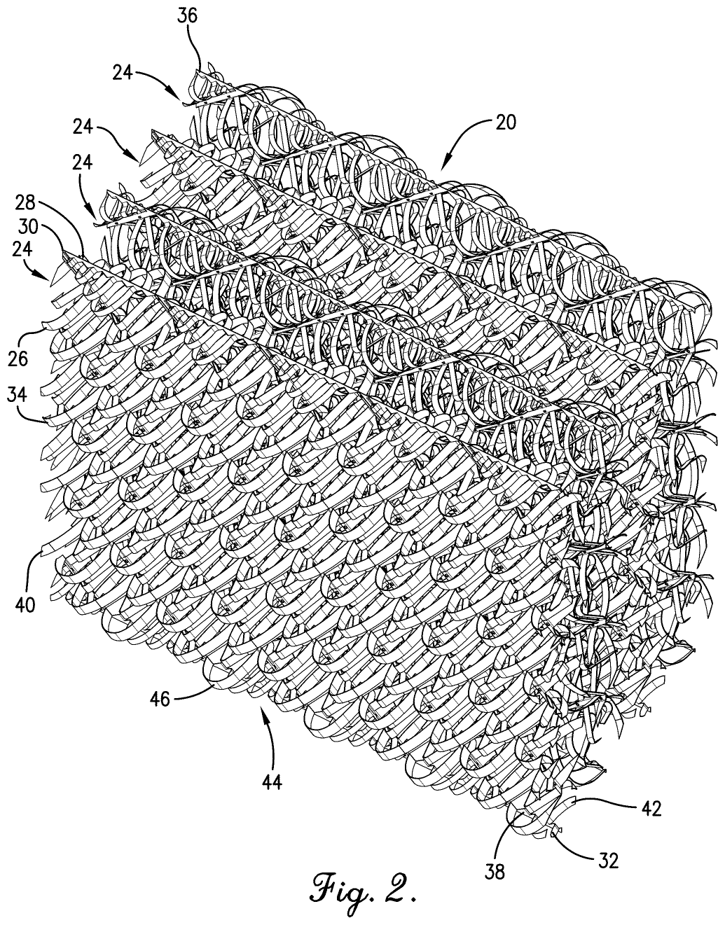

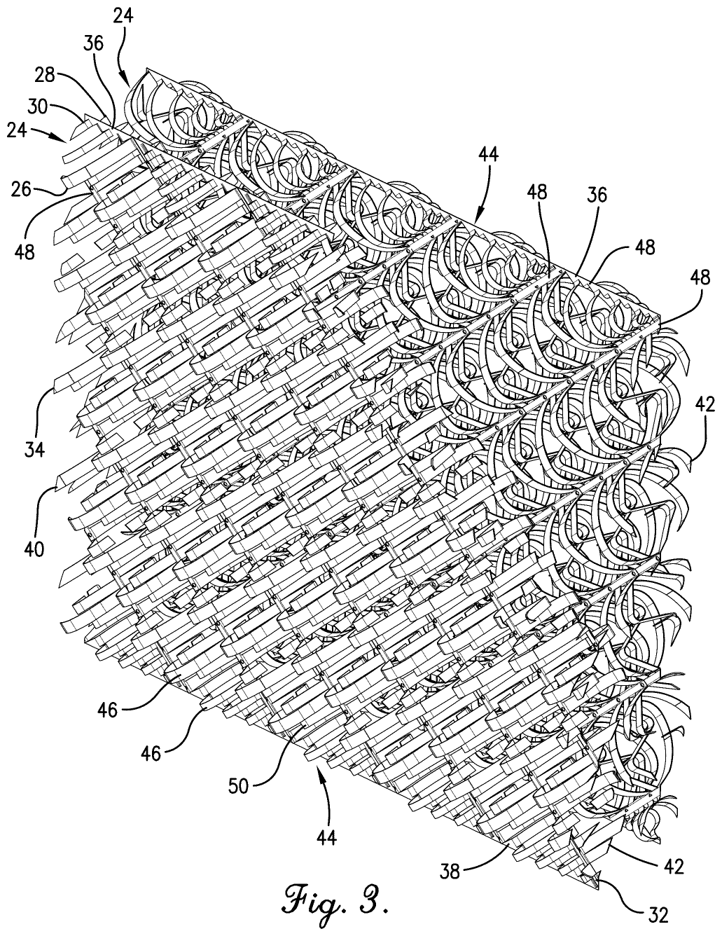

Turning additionally to FIGS. 2 and 3, each packing module 20 comprises a plurality of packing elements 24 that are positioned in an upright, parallel relationship to each other. Each packing element 24 may be formed from a planar sheet or metal or another material that is slit and deformed to create the structures described below. In other embodiments, the packing element 24 may be formed of other materials such as polymers and ceramics and by in other ways, such as 3D printing.

The packing element 24 has opposite front and back faces 26 and 28, an upper edge region 30, a lower edge region 32, and a central bulk region 34 between the upper edge region 30 and the lower edge region 32. The packing element 24 further includes an upper edge 36, a lower edge 38, and side edges 40 and 42 that cooperatively define a perimeter for the packing element 24 having a square, rectangular, parallelogram, trapezoidal or other shape.

The packing element 24 includes a plurality of side-by-side and parallel longitudinal rows 44 of arched outer rib elements 46 that are connected at their opposite ends to spaced apart side strips 48 that extend along the length of the longitudinal rows 44. The opposite ends of the outer rib elements 46 may be integral with or otherwise joined to the side strips 48. The outer rib elements 46 project outwardly in opposite directions from the side strips 48 and cooperatively define the opposite front and back faces 26 and 28 of the packing element 20.

The longitudinal rows 44 intersect the upper edge 36 of the packing element 24 at an oblique angle and may also intersect the lower edge 38 of packing element 24 at the same or different oblique angle. In some embodiments, the oblique angle may be an acute angle in the range of 25 to 80 degrees, 35 to 70 degrees, or 40 to 65 degrees. Specific examples include acute angles of 45 degrees and 60 degrees. The packing elements 24 in the packing module 20 may be arranged so that the longitudinal rows 44 in adjacent packing elements 24 are arranged in crisscrossing and contacting relationship to each other. This can best be seen in FIG. 3 where a portion of the front packing element 24 has been broken away to show that the longitudinal rows 44 in the back packing element 24 extend at a crossing angle in relation to the longitudinal rows 44 in the front packing element 24. The longitudinal rows 44 in the adjacent packing elements 24 may be in contact with each other and they may slightly nest into each other as a result of the open spaces between adjacent outer rib elements 46 within each longitudinal row 44.

In the bulk region 34, the side strips 48 in each longitudinal row 44 may extend in parallel relationship to each other. In the upper edge region 30 and in the lower edge region 32, at least one of the side strips 48 in each longitudinal row 44 converges toward the other side strip 48. This convergence of the side strips 48 in the upper edge region 30 and the lower edge region 32 causes a reduction in both the length and the outward projection of the outer rib elements 46 that are connected to the converging side strips 48. The converging side strips 48 may also form the upper and lower edges 36 and 38 of the packing element 24. It is believed that the reduction in length and outward projection of the outer rib elements 46 in the upper edge region 30 and the lower edge region 32 may lower the pressure drop and liquid build-up at an interface between adjacent stacked layers of the packing modules 20.

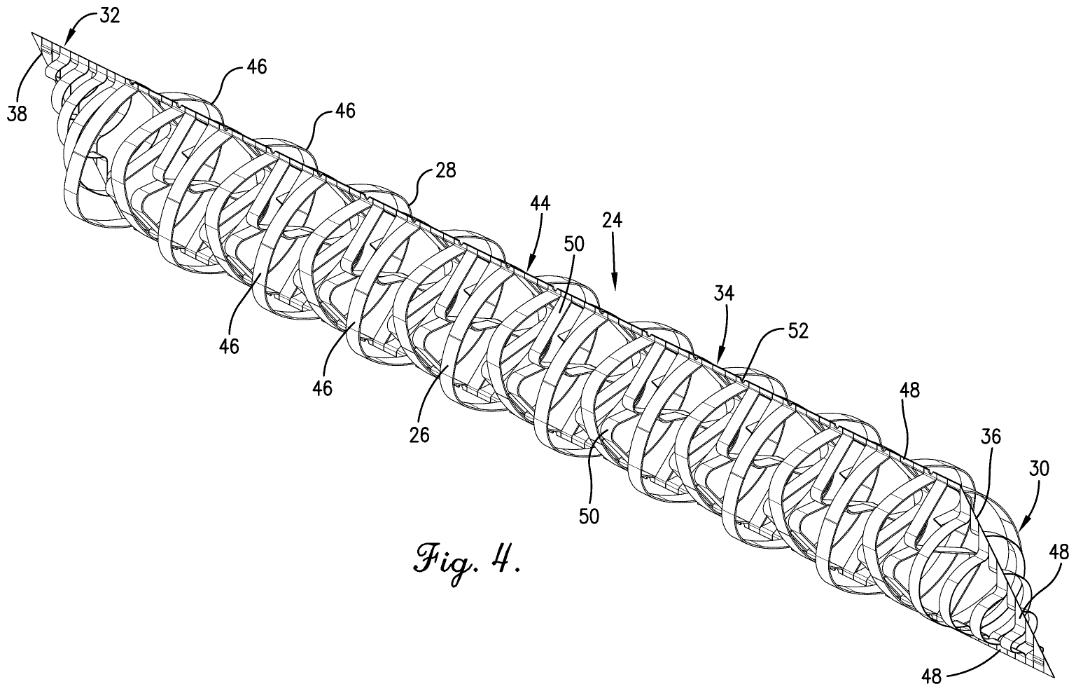

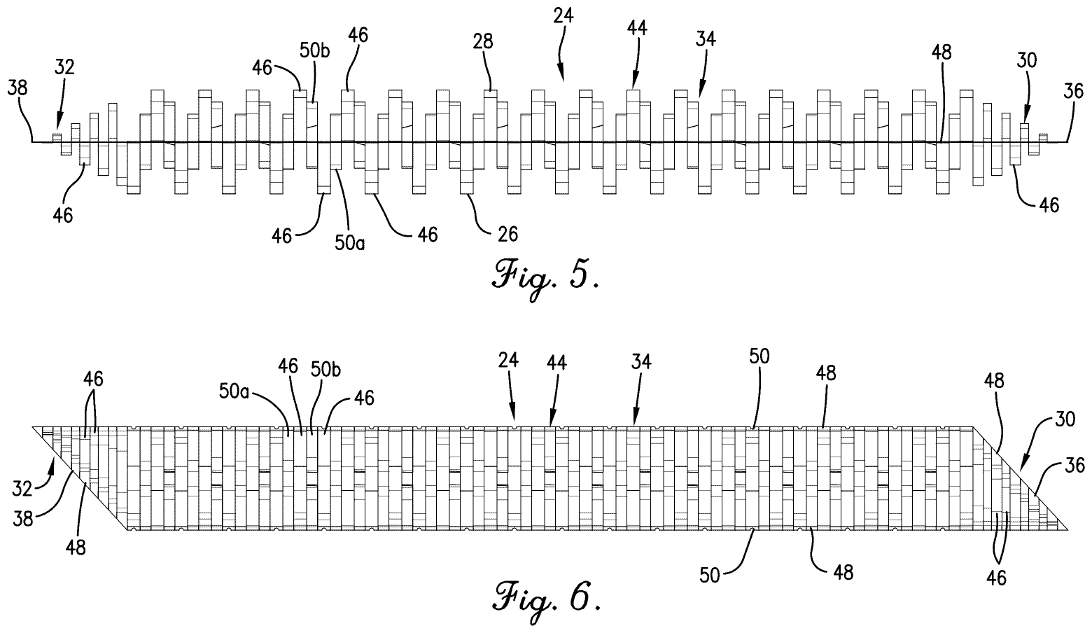

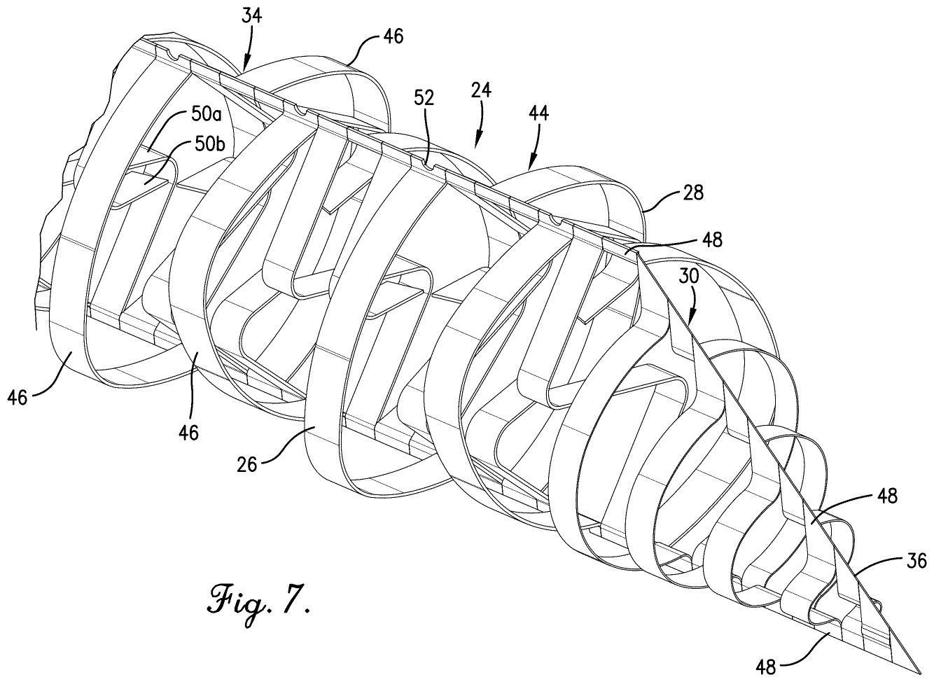

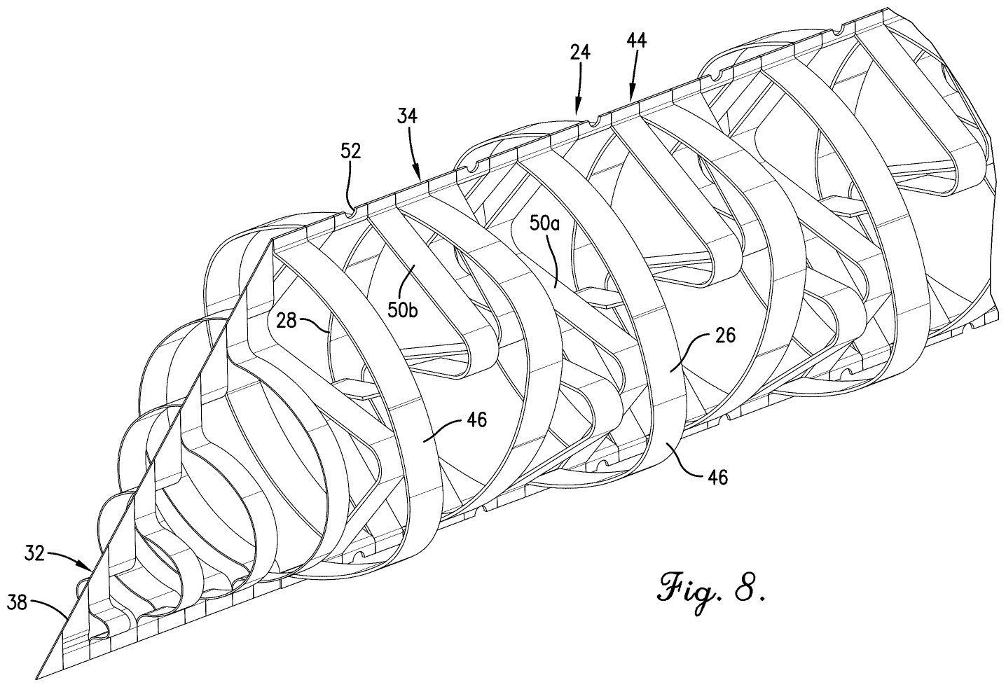

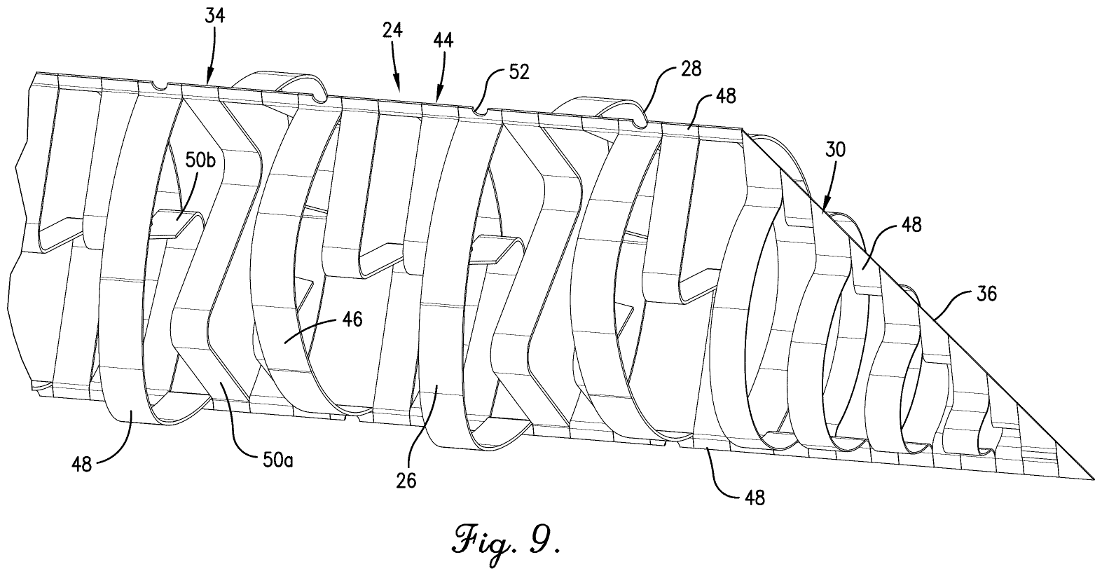

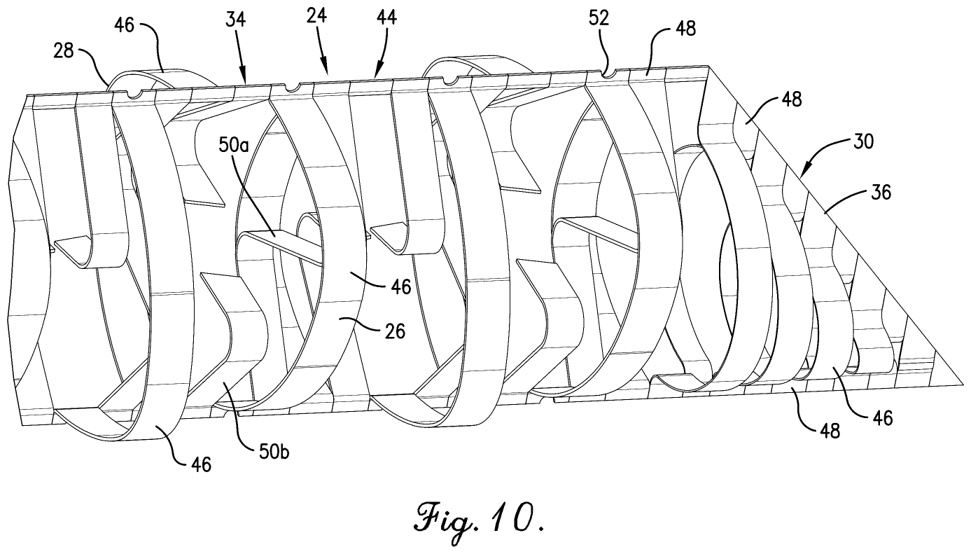

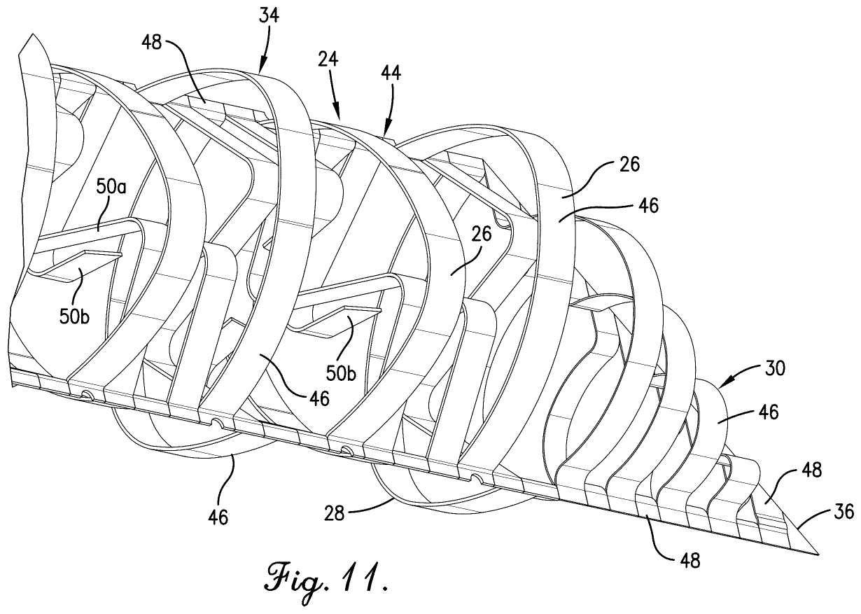

The structure of the longitudinal rows 44 can best be seen in FIGS. 4-11, which show multiple views of one longitudinal row 44 separated from the packing element 24. The illustrated longitudinal row 44 includes only half of a width of the side strips 48 shown in the packing element 24. In addition to the outer rib elements 46, the longitudinal row 44 may include additional rib elements, such as lesser rib elements 50 that are connected at their opposite ends to the side strips 48 in the same fashion as the outer rib element 46. The lesser rib elements 50 may be integral with or otherwise joined at their opposite ends to the side strips 48. The lesser rib elements 50 may be positioned within an inner volume that is defined by the opposite inner and outer faces 26 and 28 of the packing element 24. The lesser rib elements 50 may be continuous or discontinuous. For example, the lesser rib elements 50a may be continuous and have a Z configuration and the lesser rib elements 50b may be discontinuous and form first and second bent rib segments.

The lesser rib elements 50 may be positioned between adjacent outer rib elements 46 in an alternating or otherwise repeating pattern. The arrangement of the outer rib elements 46 and lesser rib elements 50 may be the same in the bulk region 34 and the upper and lower edge regions 30 and 32 or they may be different. In the illustrated embodiment, in the bulk region 34 the lesser rib element 50a is positioned between one adjacent pair of outer rib elements 46 and the lesser rib element 50b is positioned between the next adjacent pair of outer rib elements 46 in a repeating pattern along the longitudinal row 44. In the illustration embodiment, in the upper and lower edge regions 30 and 32, only outer rib elements 46 are present. Other arrangements of the outer rib elements 46 and the lesser rib elements 50 are possible and are within the scope of the present disclosure.

In one embodiment, the width of the outer rib elements 46 and lesser rib elements 50 may be selected based on the overall size of the packing element 24. As one example, for a packing element 24 having a height of approximately 250 millimeters, the outer rib elements 46 in the bulk region 34 may have a width in the range of about 1 to 8 millimeters, 2 to 7 millimeters, or 3 to 6 millimeters. The lesser rib elements 50 may have a width that is the same as, greater than, or less than that of the outer rib elements 46. The outer rib elements 46 in the upper and lower edge regions 30 and 32 may have a width that is the same as, greater than, or less than that of the outer rib elements 46 in the bulk region 34.

The side strips 48 may contain spaced apart perforations 52 that interrupt liquid flowing along the side strips 48 and allow the liquid to pass through the side strips 48. Other structures, such as bumps and/or valleys may be present in the side strips 48 to interrupt the liquid flow. The side strips 48, as well as the outer and lesser rib elements 46 and 50, may also have various types of surface texturing to facilitate spreading of the liquid on those surfaces.

As can be seen in FIG. 6, the upper edge 36 is parallel to and separated by a preselected distance from the lower edge 38 in the longitudinal row 44. The upper and lower edges 36 and 38 are formed by the converging side strips 48 and the upper and lower edge regions 30 and 32 each have a triangular projected area when viewed in projection on a plane that itself is parallel to a plane in which the side strips 48 lie. In the illustrated embodiment, the projected area is a right triangle.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

In the specification and claims, reference will be made to several terms, which shall be defined to have the following meanings. The singular forms “a,” “an,” and “the” include plural references unless the context clearly dictates otherwise.

Approximating language, as used herein throughout the specification and the claim, may be applied to modify any quantitative representation that could permissibly vary without resulting in a change in the basic function to which it is related. Accordingly, a value modified by a term or terms, such as “about” and “substantially” are not to be limited to the precise value specified. In at least some instances, the approximating language may correspond to the precision of an instrument for measuring the value. Range limitations may be combined and/or interchanged. Such ranges are identified and include all the sub-ranges contained therein unless context or language indicates otherwise.

As used herein, the terms such as “side” and similar terms are used herein solely for convenience and should be understood only in relation to each other.

The terms “coupled,” “attached to,” and the like refer to both direct coupling, fixing, or attaching, as well as indirect coupling, fixing, or attaching through one or more intermediate components or features, unless otherwise specified herein.

Although the present application sets forth a detailed description of different embodiments, it should be understood that the legal scope of the description is defined by the words of the claims and equivalent language. The detailed description is to be construed as exemplary only and does not describe every possible embodiment because describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

What is claimed is:

1. A packing element for use in forming a packing module for use in a mass transfer column, the packing element comprising:
opposite faces, an upper edge region, a lower edge region, a bulk region between the upper edge region and the lower edge region, an upper edge, and a lower edge;
a plurality of side-by-side and parallel longitudinal rows of arched outer rib elements that are connected at opposite ends to spaced apart side strips and project outwardly in opposite directions from the side strips,
wherein the longitudinal rows intersect the upper edge at an oblique angle and the lower edge at an oblique angle, in the bulk region the side strips in each longitudinal row extend in parallel relationship to each other, in the upper edge region at least one of the side strips in each longitudinal row converges toward the other side strip, in the lower edge region at least one of the side strips in each longitudinal row converges toward the other side strip, and convergence of the side strips causes a reduction in length and outward projection of the outer rib elements that are connected at opposite ends to the converging side strips.

2. The packing element of claim 1, wherein the arched outer rib elements cooperatively define the opposite faces of the packing element.

3. The packing element of claim 2, including lesser rib elements that are connected at opposite ends to the side strips and are positioned between the outer rib elements, the lesser rib elements being positioned within an inner volume defined by the opposite faces of the packing element.

4. The packing element of claim 3, wherein at least some of the lesser rib elements are each discontinuous to create first and second rib segments.

5. The packing element of claim 4, wherein the outer rib elements in the bulk region have a width that is in the range of about 1 to 8 millimeters.

6. The packing element of claim 5, wherein the outer rib elements in the upper edge region and in the lower edge region have a width that is less than that of the outer rib elements in the bulk region.

7. The packing element of claim 3, wherein the side strips in the bulk region are perforated.

8. The packing element of claim 1, wherein the upper edge is parallel to and separated by a distance from the lower edge, the upper edge and lower edge are formed by the converging side strips, and the upper and lower edge regions each have a triangular projected area when viewed in projection on a plane parallel to a plane in which the side strips lie.

9. A packing module for use in a mass transfer column, said packing module comprising:
a plurality of packing elements of claim 1 positioned in an upright, parallel relationship to each other with the longitudinal rows of adjacent packing elements arranged in crisscrossing relationship to each other.

10. The packing module of claim 9, wherein the outer rib elements of the packing elements are in contact with the outer rib elements of adjacent packing elements.

11. The packing module of claim 10, wherein the arched outer rib elements cooperatively define the opposite faces of the packing element.

12. The packing module of claim 11, including lesser rib elements that are connected at opposite ends to the side strips and are positioned between the outer rib elements, the lesser rib elements being positioned within an inner volume defined by the opposite faces of the packing element.

13. The packing module of claim 12, wherein at least some of the lesser rib elements are each discontinuous to create first and second rib segments.

14. The packing module of claim 13, wherein the outer rib elements in the bulk region have a width that is in the range of about 1 to 8 millimeters.

15. The packing module of claim 14, wherein the outer rib elements in the upper edge region and in the lower edge region have a width that is less than that of the outer rib elements in the bulk region.

16. The packing module of claim 12, wherein the side strips in the bulk region are perforated.

17. The packing module of claim 9, wherein the upper edge is parallel to and separated by a distance from the lower edge, the upper edge and lower edge are formed by the converging side strips, and the upper and lower edge regions each have a triangular projected area when viewed in projection on a plane parallel to a plane in which the side strips lie.

18. A packing module for use in a mass transfer column, said packing module comprising:
a plurality of packing elements of claim 1 positioned in an upright, parallel relationship to each other with the longitudinal rows of adjacent packing elements arranged in crisscrossing relationship to each other, wherein:
the upper edge is parallel to and separated by a distance from the lower edge,
the upper edge and lower edge are formed by the converging side strips,
the upper and lower edge regions each have a triangular projected area when viewed in projection on a plane parallel to a plane in which the side strips lie,
the outer rib elements of the packing elements are in contact with the outer rib elements of adjacent packing elements,
the arched outer rib elements cooperatively define the opposite faces of the packing element.

19. The packing module of claim 18, including lesser rib elements that are connected at opposite ends to the side strips and are positioned between the outer rib elements, the lesser rib elements being positioned within an inner volume defined by the opposite faces of the packing element.

20. The packing module of claim 13, wherein the outer rib elements in the bulk region have a width that is in the range of about 1 to 8 millimeters and the outer rib elements in the upper edge region and in the lower edge region have a width that is less than that of the outer rib elements in the bulk region.
